(19) United States
(12) Patent Application Publication
(10) Pub. No.: US 2021/0330426 A1
(43) Pub. Date: Oct. 28, 2021

(54) ENDODONTIC FILE

(71) Applicant: Kenneth C. SPRECHMAN, Port St. Lucie, FL (US)

(72) Inventor: Kenneth C. SPRECHMAN, Port St. Lucie, FL (US)

(21) Appl. No.: 17/371,393

(22) Filed: Jul. 9, 2021

Related U.S. Application Data
(63) Continuation of application No. 15/102,220, filed on Jun. 6, 2016, now abandoned.
(60) Provisional application No. 61/983,852, filed on Apr. 24, 2014.
(60) Provisional application No. 61/912,129, filed on Dec. 5, 2013.

(51) Int. Cl. A61C 5/42

(52) U.S. Cl. CPC A61C 5/42

(57) ABSTRACT

The subject invention provides an endodontic file having a handle with a distal end; and a stem, wherein the stem is attached to the distal end of the handle and extends from 13 mm to 16 mm from the distal end of the handle and wherein the stem has a) a shaft with a smooth surface and b) a working portion having a cutting portion with a plurality of spiraled cutting flutes; and wherein the length of the cutting portion is 1 mm to 5 mm. Methods of utilizing the endodontic file to treat patients are also disclosed.

### CROSS REFERENCE TO RELATED APPLICATIONS

This application is a continuation of U.S. patent application Ser. No. 15/102,220, filed Jun. 6, 2016; which is a National Stage Application of International Application No. PCT/US2014/068884, filed Dec. 5, 2014; which claims the benefit of U.S. Provisional Patent Application Ser. No. 61/912,129, filed Dec. 5, 2013, and U.S. Provisional Patent Application Serial No. 61/983,852, filed Apr. 24, 2014, the entire disclosures of which are all hereby incorporated by reference.

### BACKGROUND

The present disclosure relates to an endodontic file, and in particular to an endodontic file that is short in length.

### SUMMARY

An endodontic file in accordance with the present disclosure includes a stem of shorter length. In illustrative embodiments, a stem of an endodontic file may have a length of 18 mm or less. In another embodiment, a stem of an endodontic file may have a length of 18 mm, 17 mm, 16 mm, 15 mm, 14 mm, 11 mm, 12 mm or less. In an embodiment, a stem is 12 mm, 11 mm, 10 mm, 9 mm, 8 mm, 7 mm, 6 mm, 5 mm, 4 mm, 3 mm, 2 mm, or 1 mm.

In illustrative embodiments, methods include filing a root canal with an endodontic file having a stem of 18 mm or less. In an embodiment, methods include filing a root canal with an endodontic file having a stem of 18 mm, 17 mm, 16 mm, 15 mm, 14 mm, 11 mm, 12 mm or less. In an embodiment, a stem is 12 mm, 11 mm, 10 mm, 9 mm, 8 mm, 7 mm, 6 mm, 5 mm, 4 mm, 3 mm, 2 mm, or 1 mm. In an embodiment, the root canal canal can be infected. In an embodiment, methods include providing endodontic therapy by filing a root canal with an endodontic file having a stem of 18 mm or less in a patient with trismus.

### BRIEF DESCRIPTION OF THE DRAWINGS

FIG. 1 shows an endodontic file including a handle 10 and a stem 11, which comprises a shaft 12 and a cutting portion 14.

FIG. 2 shows a curved endodontic file. In this embodiment, a stem includes a substantially straight shaft 12 with a curved cutting portion 16

FIG. 3 shows an endodontic file of the Example. The endodontic file comprises a 14 mm stem 11. Within the stem, the endodontic file includes flutes 3 which are spiraled 9.

### DETAILED DESCRIPTION

Modern endodontic treatment provides an alternative to the extraction and replacement of an infected tooth. Retaining the original tooth structure is preferable to no tooth or an artificial tooth. Current endodontic files and methods used in endodontic therapy do not address extremely small canals differently than typical canals. Embodiments of an endodontic file described herein address access to narrow canals with a minimal (e.g., 0.06 mm or less) opening, limited access due to tooth positioning (e.g., an angulated tooth), and limited mouth opening. Endodontic files as described herein allows for improved instrumentation of when there is narrow access, limited access, or limited mouth opening.

As used herein, the terms “endodontic therapy” and “root canal therapy” refer to treating an infected or inflamed tooth pulp. Tooth pulp inhabits the “root canal” or “pulp chamber”, which contains blood vessels, nerves, and calcification. Endodontic therapy includes removing tissues of the root canal, typically all the way to the apical foramen. Access to the canal is providing by drilling through tooth structure to create an opening.

“Endodontic files” or “root canal files” are used to remove the tissues of the root canal. Subsequent to the removal of the pulp tissues, the opening in the tooth structure and the hollowed out canal are obturated with inert fillings (e.g., gutta percha, resin based composites, etc.). Generally, an endodontic file provides a tapered shape to more easily obturate the canal with inert fillings and then seal the canal.

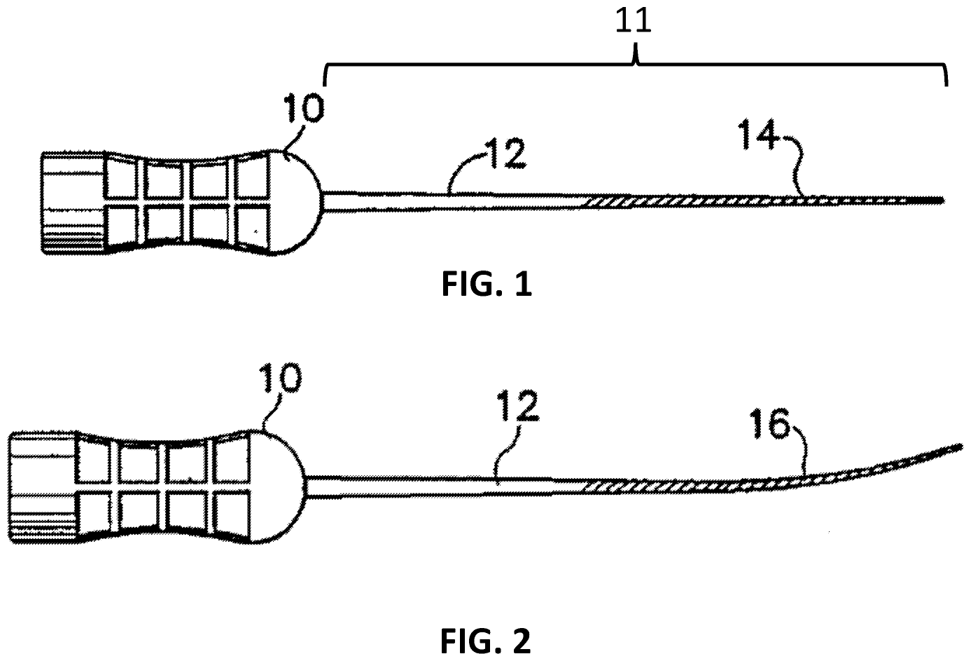

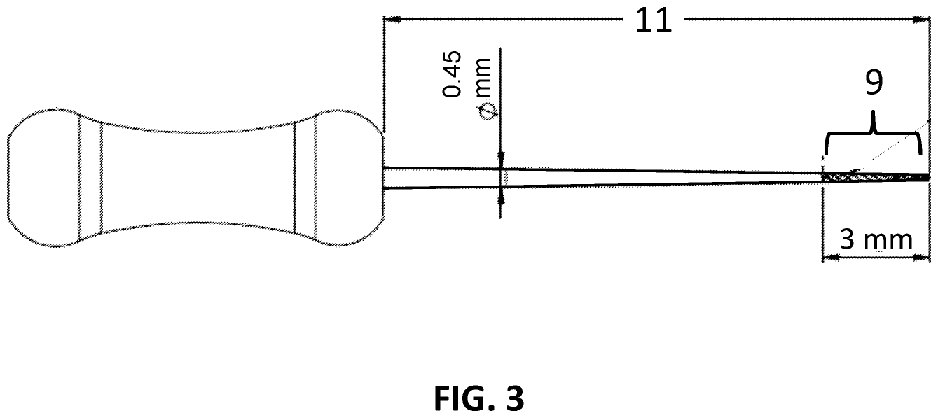

An endodontic or root canal file (FIG. 1) typically includes a handle 10 mounted atop a stem 11. A standard handle 10 is about 10 mm in length. A stem 11 can include a cutting portion 14 with a plurality of cutting flutes formed thereon. A cutting portion 14 is formed on the bottom portion of a stem. Whereas, a shaft 12 is located between the top of the cutting portion 14 and the bottom of handle 10. A shaft can be cylindrical and smooth. A shaft does not include cutting flutes. Flutes on a cutting portion 14 attach to tissue within a tooth and pull the tissue therefrom. In an embodiment, an endodontic file lacks a shaft.

In an embodiment, an endodontic file can include a stem that is curved (FIG. 2). In an embodiment, a stem includes a substantially straight shaft 12 with a curved cutting portion 16.

An endodontic file as described herein can include any type of cutting portion 14. Embodiments of the endodontic file are not limited to specific types, patterns, etc. of the cutting portion. 14

A file can be manually inserted into a tooth hole leading to the interior of the tooth and is rotated and moved in and out of the hollow interior by means of the dentist twisting, pulling, and pushing the handle 10 relative to the tooth. An endodontic file as described herein can also attach to a rotary instrument. A rotary instrument can mechanically rotate an attached endodontic file.

Typical file lengths are 21 mm, 25 mm, and 31 mm. In an embodiment, an endodontic file comprises a stem of a short length. A stem having a short length allows increase accessibility in minimal openings, particularly with a second mesiobuccal (MB₂) canal. Further, endodontic files comprising a stem of a short length provides greater visibility to the dentist, particularly when using a microscope during endodontic therapy. Endodontic files having a shorter length, and thereby a shorter cutting surface, can have an increased stiffness to the file. In an embodiment, an endodontic file comprises a stem, wherein the stem is 18 mm or less, 17 mm or less, 16 mm or less, 15 mm or less, 14 mm or less, 13 mm or less, 12 mm or less, 11 mm or less, 10 mm or less, 9 mm or less, or 8 mm or less. In an embodiment, a stem is 18 mm, 17 mm, 16 mm, 15 mm, 14 mm, 11 mm, 12 mm or less. In an embodiment, a stem is 15 mm, 14 mm, 13 mm, 12 mm, 11 mm, 10 mm, 9 mm, 8 mm, 7 mm, 6 mm, 5 mm, 4 mm, 3 mm, 2 mm, or 1 mm.

In an embodiment, an endodontic file can have minimal taper. In an embodiment, an endodontic file can have a taper of 0.04, 0.03, 0.02, or 0.01 mm. For every step back from the apex of 1 mm, the file diameter increase 0.02 mm in a 0.02 taper. In an embodiment, the endodontic file has no taper.

In an embodiment, an endodontic file includes a cutting portion 14 located on the distal end. In an embodiment, a cutting portion can be 5 mm or less, 4 mm or less, 3 mm or less, 2 mm or less, or 1 mm or less. In an embodiment, the cutting portion is about 5 mm, about 4 mm, about 3 mm, about 2 mm, or about 1 mm. The cutting portion can include 1, 2, 3, 4, or 5 flutes. In an embodiment, the cutting portion is the flue length of the endodontic file. In an embodiment, an endodontic file may have 12, 11, 10, 9, 8, 7, 6, 5, 4, or 3 flute spirals

In an embodiment, an endodontic file as described herein can include a standard handle or a handle having a decreased diameter (as compared to a standard diameter). A smaller diameter handle increases visibility, particularly in molars and particularly when endodontic therapy is performed with a microscope.

In an embodiment, a stem of an endodontic file is stainless steel or a nickel titanium alloy (NiTi). In an embodiment, a stem of an endodontic file is stainless steel.

In an embodiment, an endodontic file comprises a stem with a non-cutting end. In an embodiment, a portion of a stem above the non-cutting distal end comprises a cutting surface. In an embodiment, there is another non-cutting portion above (closer to the handle) the cutting surface that is also part of the stem, where the stem comprises a non-cutting distal end.

In patients with particular disease states, the ability to perform endodontic therapy can be limited due to trismus. The term “trismus” refers to any restriction to mouth opening, including, but not limited to, restrictions caused by trauma, surgery or radiation. A restricted mouth opening may be caused by muscle damage, joint damage (e.g., temporomandibular joint (TMJ)), connective tissue growth (i.e., scarring), conditions external to the joint, or combinations thereof. Conditions external to the joint include, but are not limited to, systemic diseases (e.g., scleroderma, central nervous disorders including multiple sclerosis, Raynaud's disease, etc.), muscle trauma, myositis, infection, tumor, TMJ pseudoankylosis, burn injuries, etc. Joint damage can include, but is not limited to, bony ankylosis, fibrous ankylosis, arthritis, infection, trauma etc. For example, patients with scleroderma may not provide a large mouth opening due to general tightening of the facial skin.

An embodiment thereby includes a method of endodontic therapy comprising filing a root canal in a patient with trismus with an endodontic file comprising a stem of 18 mm or less, 17 mm or less, 16 mm or less, 15 mm or less, 14 mm or less, 13 mm or less, 12 mm or less, 11 mm or less, 10 mm or less, 9 mm or less, or 8 mm or less. Another embodiment includes a method of endodontic therapy comprising filing a root canal in a patient with trismus with an endodontic file comprising a stem of 18 mm, 17 mm, 16 mm, 15 mm, 14 mm, 11 mm, 12 mm or less. In an embodiment, a stem is 12 mm, 11 mm, 10 mm, 9 mm, 8 mm, 7 mm, 6 mm, 5 mm, 4 mm, 3 mm, 2 mm, or 1 mm. In an embodiment, a method of endodontic therapy comprises filing a root canal in a patient with trismus with an endodontic file comprising a stem of 18 mm or less, 17 mm or less, 16 mm or less, 15 mm or less, 14 mm or less, 13 mm or less, 12 mm or less, 11 mm or less, 10 mm or less, 9 mm or less, or 8 mm or less, wherein the canal is in a premolar or molar tooth. Another embodiment includes a method of endodontic therapy comprising filing a root canal in a patient with trismus with an endodontic file comprising a stem of 18 mm, 17 mm, 16 mm, 15 mm, 14 mm, 11 mm, 12 mm or less. In an embodiment, a stem is 12 mm, 11 mm, 10 mm, 9 mm, 8 mm, 7 mm, 6 mm, 5 mm, 4 mm, 3 mm, 2 mm, or 1 mm, wherein the canal is in a premolar or molar tooth.

An embodiment thereby includes a method of endodontic therapy comprising filing a root canal with an endodontic file comprising a stem of 18 mm or less, 17 mm or less, 16 mm or less, 15 mm or less, 14 mm or less, 13 mm or less, 12 mm or less, 11 mm or less, 10 mm or less, 9 min or less, or 8 mm or less, wherein there is limited access. Another embodiment includes a method of endodontic therapy comprising filing a root canal with an endodontic file comprising a stem of 18 mm, 17 mm, 16 mm, 15 mm, 14 mm, 11 mm, 12 mm or less. In an embodiment, a stem is 12 mm, 11 mm, 10 mm, 9 mm, 8 mm, 7 mm, 6 mm, 5 mm, 4 mm, 3 mm, 2 mm, or 1 mm, wherein there is limited access. The term “access” refers to the space required to view a tooth and manipulate dental instruments to remove decay and prepare the tooth for restoration. The term “access” also refers to the opening in the crown of a tooth necessary to allow admittance to the pulp space to clean, shape, and seal the root canal. In an embodiment, a root canal with limited access is opened up by filing with an endodontic file as described herein and then is followed by filing with an endodontic file of standard length.

The term “narrow canal” refers to a root canal where a tip of an endodontic file does not enter or barely enters the canal. Such a root canal is considered narrow, calcified, or both. In an embodiment, a narrow canal is a root canal where an endodontic file of 0.06, 0.08, or 0.10 taper does not enter or barely enters the canal. In an embodiment, a method of endodontic therapy comprises filing a narrow root canal, a calcified root canal, or a narrow and calcified root canal with an endodontic file comprising a stem of 18 mm or less, 17 mm or less, 16 mm or less, 15 mm or less, 14 mm or less, 13 mm or less, 12 mm or less, 11 mm or less, 10 mm or less, 9 mm or less, or 8 mm or less. Another embodiment includes a method of endodontic therapy comprising filing a narrow root canal, a calcified root canal, or a narrow and calcified root canal with an endodontic file comprising a stem of 18 mm, 17 mm, 16 mm, 15 mm, 14 mm, 11 mm, 12 mm or less. In an embodiment, a stem is 12 mm, 11 mm, 10 mm, 9 mm, 8 mm, 7 mm, 6 mm, 5 mm, 4 mm, 3 mm, 2 mm, or 1 mm. In an illustrative embodiment, a method of endodontic therapy comprises filing a narrow root canal, wherein the narrow root canal does not fit an endodontic file of 0.06, 0.08, or 0.10 taper. In an embodiment, a root canal with a narrow canal is opened up by filing with an endodontic file as described herein and then is followed by filing with an endodontic file of standard length.

Endodontic files as described herein allows for improved instrumentation of when there is narrow access, limited access, or limited mouth opening. The improved instrumentation particularly helps when the tooth being treated for endodontic therapy is a molar (tooth nos. 1-3, 14-19, and 30-32) and/or a premolar (tooth nos. 4-5, 12-13, 20-21, and 28-29).

### EXAMPLE

Three NiTi endodontic files comprising a stem having a shorter length were produced. A size 0.08, a size 0.10, and a size 0.15 endodontic files were produced with a stem of 14 mm and a taper of 0.03. The cutting surface of the files had 4 flutes (9 spirals) and a length of 3 mm. Additionally, the files had a tip angle of 75°. The files had no shafting.

| | Diameter measurement from the tip of the file (mm) | | | | | |
|---|---|---|---|---|---|---|
| Size | 0.5 | 1 | 3 | 8 | 10 | 12 |
| 0.08 | 0.10 | 0.11 | 0.17 | 0.32 | 0.38 | 0.44 |
| 0.10 | 0.12 | 0.13 | 0.19 | 0.34 | 0.40 | 0.46 |
| 0.15 | 0.17 | 0.18 | 0.24 | 0.39 | 0.45 | N/A |

One set of endodontic files were produced with increased flute depth as compared to a standard flute depth. This provided increased flexibility compared to an endodontic file of the same length with a standard flute depth. A second set of endodontic files were produced with a slightly decreased flute depth as compared to a standard flute depth. The endodontic files with the decreased flute depth had an increased stiffness.

I claim:

1. An endodontic file consisting of:
a handle having a distal end; and
a stem, wherein the stem is attached to the distal end of the handle and extends from 13 mm to 16 mm in length from said distal end of the handle and wherein the stem consists of,
a) a shaft with a smooth surface and a proximal end that extends from the distal end of the handle and tapers to a distal end of the shaft, and
b) a working portion that begins at the distal end of the shaft, wherein the working portion consists of a cutting portion having a plurality of spiraled cutting flutes; and
wherein the length of the cutting portion is 1 mm to 4 mm.

2. The endodontic file of claim 1, wherein the length of the stem is 14 mm to 15 mm.

3. The endodontic file of claim 1, wherein the cutting portion is 3 mm to 4 mm in length.

4. The endodontic file of claim 1, wherein the cutting portion has 2 to 5 spiraled flutes.

5. The endodontic file of claim 4, wherein the cutting portion has 4 spiraled flutes.

6. A method of endodontic therapy comprising filing a root canal in a tooth with an endodontic file of claim 1.

7. The method of claim 6, wherein the root canal is in at least one of a molar and a premolar tooth.

8. The endodontic file, according to claim 1, wherein the stem comprises stainless steel.

9. The endodontic file, according to claim 1, wherein the length of the stem is 14 mm and the length of the cutting portion is 4 mm.
